(19) United States
(12) Patent Application Publication
(10) Pub. No.: US 2003/0010802 A1
(43) Pub. Date: Jan. 16, 2003

(54) Device for cutting soft flexible, sheet-like workpieces

(75) Inventors: Gottfried Blaimschein, Steyr (AT); Franz Heidlmayer, St. Marien (AT)

Correspondence Address: Kurt Kelman, COLLARD & ROE, P.C., 1077 Northern Boulevard, Roslyn, NY, 11576, US

(73) Assignee: GFM GmbH, Steyr (AT)

(21) Appl. No.: 10/191,311

(22) Filed: Jul. 9, 2002

(30) Foreign Application Priority Data
Jul. 10, 2001 (AT) A 1072/01

(51) Int. Cl. B26D 7/14

(52) U.S. Cl. 225/96; 83/175; 83/466.1

(57) ABSTRACT

A device is described for cutting soft, flexible sheet-like workpieces (1) which has a work support (2), a cutter head (3) which can be positioned against the work support (2) and has at least one cutter (4), and a device for holding down the workpiece (1) to operate in conjunction with the cutter head (3), whereby provision is made for said device to be located laterally adjacent to the cutter (4) and whereby said device can be adjusted in relation to said cutter perpendicular to the work support (2). In order to achieve advantageous construction conditions it is proposed that the hold-down device consists of at least one pressure roller (5) which forms a conical roller surface (18) and which has a trunnion (6) extending transversely in relation to the direction of cut and inclined at an angle to the work support (2).

### FIELD OF THE INVENTION

The invention relates to a device for cutting soft flexible sheet-like workpieces which has a work support, a cutter head which can be positioned against the work support and has at least one cutter, and a device for holding down the workpiece to operate in conjunction with the cutter head, whereby provision is made for said device to be positioned laterally adjacent to the cutter and whereby said device can be adjusted in relation to said cutter perpendicular to the work support.

### DESCRIPTION OF THE PRIOR ART

A cutter head with at least one cutter is already known (DE 198 55 803 A1) for the purpose of cutting and chamfering the cut edges of sheet-like workpieces, whereby the cutter head can be positioned on the work support upon which a workpiece is mounted and is propelled along a preset cutting path. The correct cutting position of the workpiece on the work support is maintained by a sliding shoe working in conjunction with the cutter head, whereby said shoe not only holds down the workpiece against the work support, but also maintains the preset cutting depth which can be set by adjusting the position of the sliding shoe in relation to the cutter perpendicular to the work support. However, in the case of soft, flexible sheet-like workpieces which tend to develop creases, such as is the case with leather, sliding shoes of this type can result in the movement of creases which might develop, resulting in a loss of cutting precision due to sectional changes in the position of the workpiece associated with such movement. Moreover, the danger exists that the surface of the workpiece may become damaged by the sliding shoe if the surface of the workpiece is delicate.

### SUMMARY OF THE INVENTION

It is therefore an object of the invention to provide a device for cutting soft, flexible workpieces of the type described above in such a way that it can be ensured that virtually irrespective of the workpiece material, the workpiece will be held on the work support without having to worry about damaging the surface of the workpiece and while allowing the cutter to travel precisely.

The invention accomplishes the desired object by providing a hold-down device which comprises at least one pressure roller which forms a conical roller surface, whereby the trunnion of said pressure roller is inclined at an angle to the work support and extends transversely in relation to the cutting direction.

By employing at least one pressure roller as a hold-down device it is firstly possible to prevent any sliding movement from occurring between the hold-down device and the workpiece, preventing the problems which occur as a result of such sliding movement in the case of a sliding shoe. The differing circumferential velocities of the pressure roller resulting from the conical shape of the roller surface has no practical significance in this context. However, the inclination of the pressure roller trunnion as dictated by the conical roller surface is essential in order to be able to position the hold-down device on the workpiece as closely as possible adjacent to the cutter. A workpiece holder of this type is equally suitable for workpieces made of various materials as the workpiece is held down onto the work surface with downward pressure in the vicinity of the cutter's operation in a manner suitable for cutting as a result of the rolling action of the conical roller surface of the pressure roller upon the surface of the workpiece in the immediate vicinity of the cutter's action. In this way it is possible to cut workpieces which are soft and flexible and tend to form creases and also workpieces of fibrous material, which otherwise require the use of a surface foil, due to the fact that the pressure roller presses the fibers in the vicinity of cutting onto the work support with sufficient downward pressure to hold them in a manner which prevents them from becoming displaced in the direction of cut, without having to accept disadvantageous consequences for the workpiece resulting from an advancing hold-down device.

In order to achieve a comparatively large pressure roller diameter which is advantageous for exerting pressure on the workpiece, while minimizing the comparative conicality of the pressure roller, the pressure roller can be developed in the shape of a pot, whereby the open wall of the pot facing the cutter forms the roller surface. This pot-shaped pressure roller allows the cutter head to be partially positioned within the pot section of the pressure roller in such a way that the pressure roller can be placed upon the workpiece in the immediate vicinity of the cutter.

Notwithstanding the fact that subject to the characteristics of the workpiece in some cases a single pressure roller may be sufficient, in general optimal cutting conditions can best be ensured if two pressure rollers are arranged symmetrically in relation to a plane which extends in the direction of cut and is perpendicular to the work support. In this case and with respect to guiding the cutter, the workpiece is held symmetrically in an area immediately adjacent to the point where the cutter is cutting, ensuring optimal conditions for precision cutting.

Depending on the cutting conditions and the type of workpieces to be cut, the pressure rollers of such hold-down devices can be mounted in a freely rotating or actuated manner. If provision is made for pressure roller actuators it is recommended that the drive for each pressure roller is controlled as a function of the cutting path in order to take into account the variations in the average circumferential velocity of the roller surface of each pressure roller with respect to the cutting speed as a function of the cutting path. As a result of the lateral distance of the pressure rollers from the cutter, the radii of the pressure roller rolling surfaces vary with respect to a radius of curvature for the cutting path.

As previously indicated, the rolling motion of the conical roller surfaces upon the workpiece being held down can result in the advance-related shearing stress generated by the pressure rollers being kept relatively minimal even in the case of intense pressure loads. This results is advantageous conditions for controlling the downward pressure of the pressure roller or pressure rollers upon the workpiece. For this purpose provision only needs to be made for an appropriate control device for exerting pressure upon the pressure rollers which can be adjusted perpendicularly to the work support. In the simplest case, this device can consist of at least one compression spring, the compression of which can be set in advance.

If the area of the cut edges of the workpieces are, for instance, to be thermally hardened by means of melting, the pressure rollers in accordance with the invention can be employed advantageously for this purpose. Provision only needs to be made for a heating device for the pressure roller or pressure rollers in the area of the roller surfaces in order to ensure that heat is conducted through the roller surfaces to the vicinity of the cut edges.

The construction of the bearings for the pressure roller or pair of pressure rollers can be designed in various ways. A particularly simple construction design involves making provision for a pressure roller housing comprising a supporting collar which can be connected to the cutter head and a ring bearing which can be slid axially in opposition to the force exerted by a spring or springs and in which the pressure roller or pressure rollers can be seated. The housing for the pressure roller or pressure rollers is attached through the supporting collar coaxially to the cutter head such that when the cutter head is rotated to guide the cutter along a predetermined cutting path each pressure roller is driven with it, maintaining the spatial configuration in relation to the cutter head which is required in order to hold the workpiece. With the aid of the sprung support provided by the ring bearing in relation to the supporting collar, the pressure rollers determine the pressure load for each workpiece concerned.

### BRIEF DESCRIPTION OF THE DRAWING

The drawing shows an embodiment of the invention.

FIG. 1 shows a device in accordance with the invention for cutting soft, flexible sheet-like workpieces in simplified axial cross-section at a right angle to the direction of cut,

FIG. 2 shows a partially exposed horizontal projection of the housing containing the pressure rollers, and

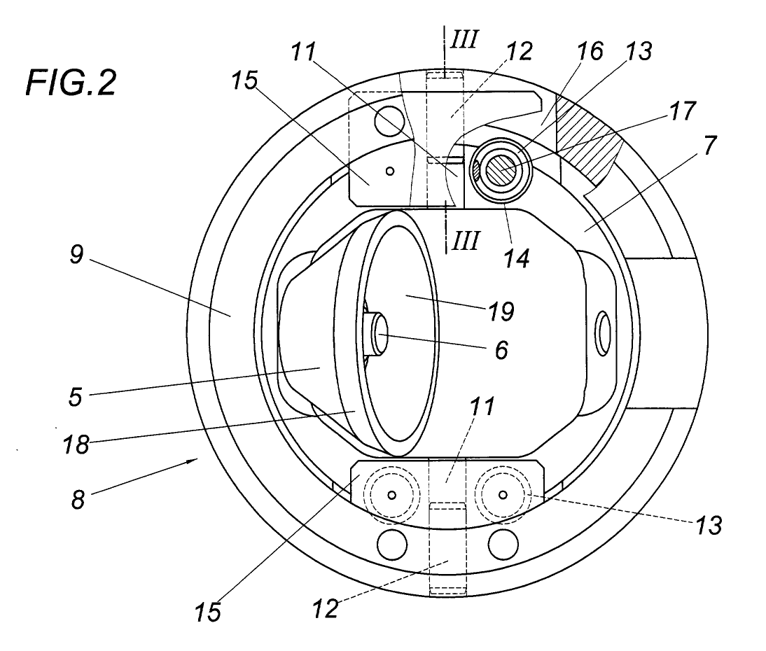

FIG. 3 a section along the line III-III in FIG. 2.

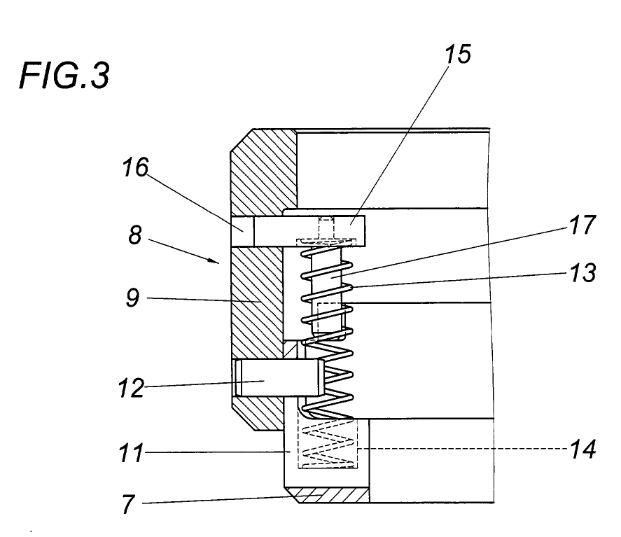

### DESCRIPTION OF THE PREFERRED EMBODIMENT

In accordance with the exemplary embodiment provision is made for the soft, flexible sheet-like workpiece 1 to have a work support 2, which is generally a cutting table, in relation to which a cutter head 3 can be propelled along a predetermined cutting path. This cutter head 3 is equipped with at least one cutter 4 which can be developed as a paring knife for cutting grooves or chamfers or as a parting blade for cutting through a workpiece 1. Naturally a combination of paring knife and parting blade is possible. The novelty with respect to conventional cutter heads 3 is the provision made for a hold-down device for pressing the workpiece 1 onto the work support 2 in a manner suitable for cutting, whereby said device consists of two pressure rollers 5, the trunnions 6 of which extend transversely to the direction of cut and are inclined at an angle to the work support 2. The trunnions 6 of the pressure rollers 5 are mounted in a ring bearing 7 within a housing 8 which in addition to the ring bearing 7 also encompasses a supporting collar 9 which can be connected to the cutter head 3. The housing 8 is thereby co-axially attached to the rotational axis 10 of the cutter head 3 in such a way that the pressure rollers 5 make the same rotational movements around the rotational axis 10 which are essential for guiding the cutter along the predetermined cutting path.

The ring bearing 7 can slide axially within the supporting collar 9 with the aid of guide pins 12 which protrude into axially-aligned elongated holes 11 in the ring bearing 7, with the ring bearing 7 being held in an end stop position by means of compression springs 13, a position from where the ring bearing 7 can be pushed into the housing 8. The compression springs 13 which are each supported in a location hole 14 in the ring bearing 7 also abut against pressure plates 15 which are set into peripheral slots 16 in the supporting collar 9. These peripheral slots 16 also bear axial pins 17 for guiding the compression springs 13.

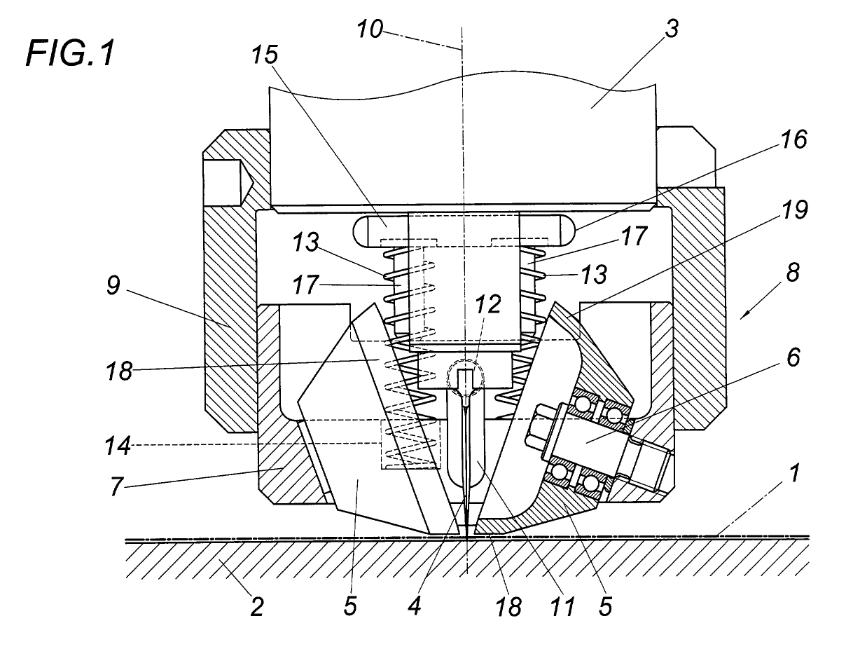

The pressure rollers 5 in the embodiment presented are mounted in order to rotate freely, but can also be driven by means of controlled actuators as a function of each cutting path. These pressure rollers 5 roll along conical roller surfaces 18 over the workpiece 1, exerting pressure accordingly and the workpiece 1 is tensioned with downward pressure in a manner suitable for cutting by means of the pressure exerted directly adjacent to the cutter 4. As can be appreciated directly from FIG. 1 in particular, the pressure rollers 5 are developed in the form of pots, wherein the pot walls 19 of the pots opened toward the cutters 4 form the roller surfaces 18. Despite the need for lateral space for the blade holder, the hollow spaces formed as a result of the pot-shaped design of the pressure rollers 5 allow minimal lateral clearances to be maintained between the cutter 4 and the pressure rollers 5, which is advantageous for cutting conditions.

The invention is clearly not confined to the embodiment presented herein. Therefore, the pressure rollers could, for instance, be able to be heated at least in the vicinity of the roller surfaces 18 in order to subject the cut edges to heat treatment by means of the pressure rollers 5. Moreover, the pressure of the pressure rollers 5 acting against the workpiece 1 could be controlled by means of a control device corresponding to the requirements in each case. The mechanical requirements for doing so exist as a result of the ability to slide the ring bearing 7 in an axial direction within the housing 8.

1. A device for cutting soft, flexible sheet-like workpieces which has a work support, a cutter head which can be positioned against the work support and has at least one cutter, and a device for holding down the workpiece to operate in conjunction with the cutter head, whereby provision is made for said device to be located laterally adjacent to the cutter and whereby said device can be adjusted in relation to said cutter perpendicular to the work support, wherein the hold-down device consists of at least one pressure roller (5) which forms a conical roller surface (18) and which has a trunnion (6) extending transversely with respect to the direction of cut and inclined at an angle to the work support (2).

2. A device in accordance with claim 1, wherein the pressure roller (5) is pot-shaped and the wall of the pot (19) open toward the cutter (4) forms the roller surface (18).

3. A device in accordance with claims 1 or 2, wherein two pressure rollers (5) are arranged symmetrically in relation to a plane which extends in the direction of cut and is perpendicular to the work support (2).

4. A device in accordance with any one of the claims 1 to 3, wherein provision is made for a drive to actuate the pressure roller or pressure rollers (5).

5. A device in accordance with any one of the claims 1 to 4, wherein the drive for each pressure roller (5) can be controlled as a function of the cutting path.

6. A device in accordance with any one of the claims 1 to 5, wherein provision is made for a control unit to govern the force exerted by the pressure roller or pressure rollers (5).

7. A device in accordance with any one of the claims 1 to 6, wherein provision is made for a heating device for the pressure roller or pressure rollers (5) at least in the vicinity of the roller surface (18).

8. A device in accordance with any one of the claims 1 to 7, wherein provision is made for a housing (8) for the pressure roller or pressure rollers (5) which comprises a supporting ring (9) which can be connected to the cutter head (3) and a ring bearing (7) which is located in the supporting ring (9), which can be slid axially in opposition to the force of the spring, and in which the pressure roller or pressure rollers (5) can be positioned.
